(19) United States
(12) Patent Application Publication
(10) Pub. No.: US 2014/0306090 A1
(43) Pub. Date: Oct. 16, 2014

(54) MOLD CORE AND METHOD FOR MANUFACTURING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 14/244,908

(22) Filed: Apr. 4, 2014

(30) Foreign Application Priority Data
Apr. 10, 2013 (TW) 102112602

(51) Int. Cl. B29C 33/38

(52) U.S. Cl. CPC B29C 33/38
USPC 249/114.1; 427/576

(57) ABSTRACT

A mold core includes a main body, an aluminum oxide film formed on the main body, and a self-assembled monomolecular layer formed on an outer surface of the aluminum oxide film. The main body includes a molding surface on which the aluminum oxide film is formed for a high degree of hardness. The monomolecular layer is self-assembling, being a hydrophobic layer of a normal perfluoro fatty acid grafted on the aluminum oxide film.

### BACKGROUND

1. Technical Field

The present disclosure relates to injection molds, and particularly to a mold core of an injection mold.

2. Description of Related Art

Injection molds are configured for molding products with predetermined shapes. An injection mold includes a mold core for molding a high precision surface(s) of a product to be molded. The mold core is typically made from metal with low hydrophobic properties, and a molding material often has a high viscosity. Therefore, scraps may be left on an end surface of the mold core after a molding process. The scraps must be removed before a next molding process to eliminate contamination. Therefore, the mold core should be frequently disassembled from the injection mold and cleaned, this is troublesome and inconvenient.

Therefore, what is needed is a mold core and a method for manufacturing the mold core addressing the limitations described.

### BRIEF DESCRIPTION OF THE DRAWINGS

The components of the drawing are not necessarily drawn to scale, the emphasis instead being placed upon clearly illustrating the principles of the embodiments of the present disclosure.

FIG. 1 is an isometric view of a mold core, according to an exemplary embodiment of the present disclosure.

FIG. 2 is a cross section of the mold core of FIG. 1, taken along line II-II.

FIG. 3 is a schematic view for manufacturing the mold core of FIG. 1.

FIG. 4 is a schematic view of the formation of a self-assembled monomolecular layer on an aluminum oxide film.

### DETAILED DESCRIPTION

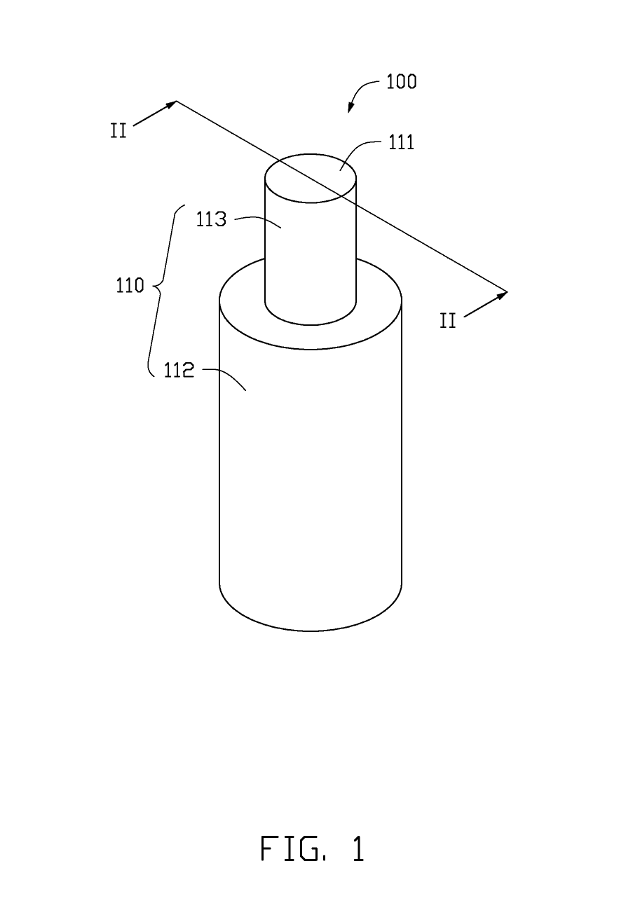

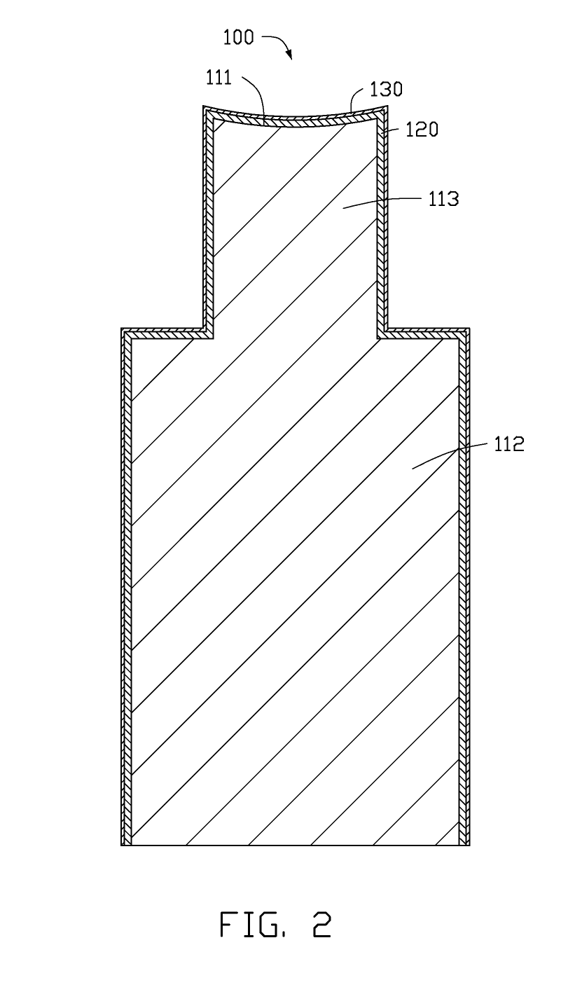

Referring to FIGS. 1-2, a mold core 100 of an exemplary embodiment of the present disclosure is shown. The mold core 100 includes a main body 110, an aluminum oxide film 120 on an outer surface of the main body 110, and a self-assembled monomolecular layer 130 formed on an outer surface of the aluminum oxide film 120.

A shape of the main body 110 is dependent on different requirements. In this embodiment, the main body 110 includes a mounting portion 112 and a molding portion 113. The mounting portion 112 and the molding portion 113 are substantially cylindrical, and a diameter of the mounting portion 112 is larger than that of the molding portion 113. The mounting portion 112 and the molding portion 113 are coaxial with each other. The molding portion 113 includes a molding surface 111 facing away from the mounting portion 113. A shape of the molding surface 111 is defined according to a shape of product (not shown) to be molded. For example, the molding surface 111 can be a curved surface, such as an aspherical surface or a spherical surface. If the molding portion 113 is used for forming a blind hole, a total outer surface of the molding portion 113 would be the molding surface 111. In this embodiment, the molding surface 111 is an aspherical concave surface.

A thickness of the aluminum oxide film 120 is in a range of 80-120 nanometers. In this embodiment, the thickness of the aluminum oxide film 120 is 100 nanometers. The aluminum oxide film 120 can be formed by an atomic layer deposition (ALD) method. The aluminum oxide film 120 has a high hardness. In this embodiment, the aluminum oxide film 120 is formed on a total outer surface of the main body 110. Alternatively, the aluminum oxide file 120 can be formed only on the molding surface 111.

The self-assembled monomolecular layer 130 is a layer of a normal perfluoro fatty acid grafted on the aluminum oxide film 120.

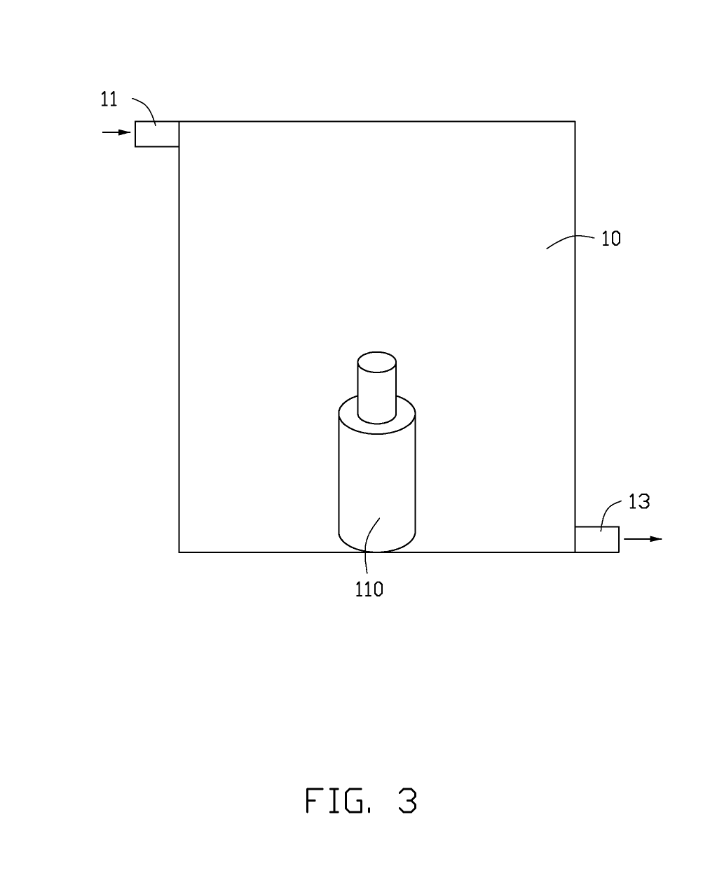

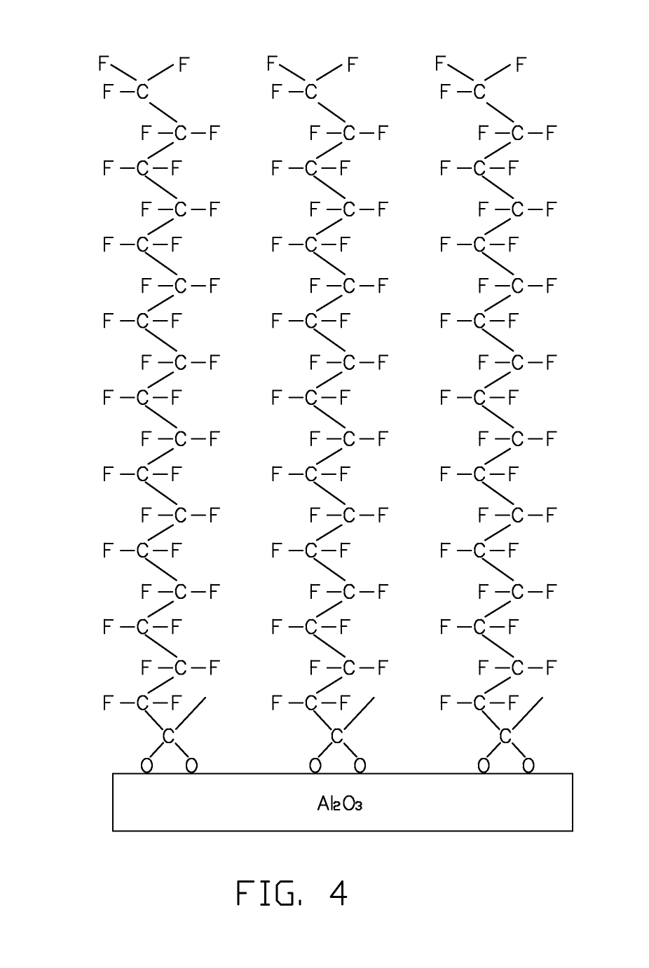

Referring to FIGS. 1, 3, and 4, a method for manufacturing the mold core 100, according to an exemplary embodiment, includes the following steps:

In a first step, a main body 110 is provided.

A shape of the main body 110 can be changed according to different requirements. In this embodiment, the main body 110 includes a mounting portion 112 and a molding portion 113. The mounting portion 112 and the molding portion 113 are substantially cylindrical, and a diameter of the mounting portion 112 is larger than that of the molding portion. The mounting portion 112 and the molding portion 113 are coaxial with each other. The molding portion 113 includes a molding surface 111 facing away from the mounting portion 112. A shape of the molding surface 111 is defined according to a shape of desired product (not shown) to be molded. For example, the molding surface 111 can be a curved surface, such as an aspherical surface or a spherical surface. If the molding portion 113 is used for forming a blind hole, a total outer surface of the molding portion 113 would be the molding surface 111. In this embodiment, the molding surface 111 is an aspherical concave surface.

In a second step, an aluminum oxide film 120 is formed on the molding surface 111 of main body 110.

In this embodiment, the aluminum oxide film 120 is formed by an atomic layer deposition (ALD) method. In detail, the main body 110 is positioned in a reaction chamber 10. The reaction chamber 10 defines an air inlet 11 and an air outlet 13. Air in an inner space of the reaction chamber 10 is pumped out of the reaction chamber 10 to achieve a degree of vacuum in the reaction chamber 11 of 0.001 torr. The reaction chamber 110 is uniformly heated to increase a temperature of the main body 110 to about 220-240° C. A predecessor and a reactant are alternately injected into the reaction chamber 10 through the air inlet 11. The predecessor is trimethyl aluminum (TMA), and the reactant is oxygen. A reaction time is controlled to generated an aluminum oxide film 120 with thickness of about 80-120 nanometers.

In a third step, a self-assembled monomolecular layer 130 is formed on the aluminum oxide film 120.

The self-assembled monomolecular layer 130 is formed by the following method:

First, air in the reaction chamber 10 is pumped out of the reaction chamber 10, an inert gas is injected into the reaction chamber 10, and a temperature in the reaction chamber 10 is adjusted to about 190-210° C. In this embodiment, the temperature in the reaction chamber 10 is adjusted to 200° C. Second, a gas of a normal perfluoro fatty acid is injected into the reaction chamber 10, and the temperature in the reaction chamber 10 is maintained for annealing purposes for three hours. During the annealing process, the normal perfluoro fatty acid is grafted on the aluminum oxide film 120 to generate the self-assembled monomolecular layer 130. The self-assembled monomolecular layer 130 has the property of high hydrophobicity. To increase a thermal stability of the self-assembled monomolecular layer 130, a number of carbon atoms in a molecular formula of the normal perfluoro fatty acid is more than ten. In this embodiment, the normal perfluoro fatty acid is perfluorostearic acid, which has a molecular formula of CH₃(CF₂)₁₆COOH. A volume of the gas of the normal perfluoro fatty acid injected into the reaction chamber 10 is about 0.2 percent of an internal volume of the reaction chamber 10.

The method for manufacturing the mold core 100 further includes a step for cleaning the aluminum oxide film 120. In detail, a surface of the aluminum oxide film 120 is cleaned by the application of chloroform, acetone, alcohol, and deionized water in that order to remove the normal perfluoro fatty acid physically adsorbed on the surface of the aluminum oxide film 120.

Because of the aluminum oxide film 120 and the self-assembled monomolecular layer 130, the molding surface 111 of the mold core 100 has both a high hardness and a high hydrophobicity property, therefore, the mold core 100 has a better scratch resistance and anti-adhesion, and scraps will not form on the mold core 100.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the disclosure.

What is claimed is:

1. A mold core, comprising:
a main body comprising a molding surface;
an aluminum oxide film on the molding surface; and
a self-assembled monomolecular layer on an outer surface of the aluminum oxide film, and the self-assembled monomolecular layer being a layer of a normal perfluoro fatty acid grafted on the aluminum oxide film.

2. The mold core of claim 1, wherein a thickness of the aluminum oxide film is in a range of 80-120 nanometers.

3. The mold core of claim 2, wherein the thickness of the aluminum oxide film is 100 nanometers.

4. The mold core of claim 1, wherein the main body comprises a mounting portion and a molding portion connected to the mounting portion, the molding surface is formed on the molding portion.

5. The mold core of claim 4, wherein the mounting portion and the molding portion are substantially cylindrical-shaped, and a diameter of the mounting portion is larger than a diameter of the molding portion.

6. The mold core of claim 5, wherein the mounting portion and the molding portion are coaxial with each other.

7. The mold core of claim 4, wherein the molding surface is an end surface of the molding portion facing away from the mounting portion.

8. The mold core of claim 4, wherein the molding surface is a total outer surface of the molding portion.

9. The mold core of claim 1, wherein the normal perfluoro fatty acid is perfluorostearic acid.

10. A method for manufacturing a molding core, comprising:
providing a main body comprising a molding surface;
forming an aluminum oxide film on the molding surface; and
forming a self-assembled monomolecular layer on an outer surface of the aluminum oxide film, the self-assembled monomolecular layer being a layer of a normal perfluoro fatty acid grafted on the aluminum oxide film.

11. The method of claim 10, wherein the aluminum oxide film is formed by an atomic layer deposition method.

12. The method of claim 10, wherein the aluminum oxide film is formed on the molding surface by a method comprising:
providing a reaction chamber;
positioning the main body in the reaction chamber;
pumping air in an inner space of the reaction chamber out of the reaction chamber to keep a predetermined degree of vacuum in the reaction chamber;
heating the reaction chamber to increase a temperature of the main body to a predetermined range; and
injecting trimethyl aluminum and oxygen into the reaction chamber to generate the aluminum oxide film.

13. The method of claim 12, wherein the degree of vacuum in the reaction chamber is 0.001 torrs.

14. The method of claim 12, wherein the range of the temperature in the reaction chamber is 240-260° C.

15. The method of claim 12, wherein the self-assembled monomolecular layer is formed on the aluminum oxide film by a method comprising:
injecting an inert gas into the reaction chamber after the aluminum oxide film being formed;
adjusting a temperature in the reaction chamber to a range of 190-210° C.;
injecting a gas of the normal perfluoro fatty acid into the reaction chamber; and
maintaining the temperature in the reaction chamber and annealing for three hours to generate the self-assembled monomolecular layer.

16. The method of claim 10, wherein the normal perfluoro fatty acid is perfluorostearic acid.
